(19) United States
(12) Patent Application Publication
(10) Pub. No.: US 2003/0003898 A1
(43) Pub. Date: Jan. 2, 2003

(54) Utilizing parallel available services over a wireless network

(75) Inventors: Dwip N. Banerjee, Austin, TX (US); Jessie Ann Hays Haug, Austin, TX (US); Vasu Vallabhaneni, Austin, TX (US)

Correspondence Address: Kelly K. Kordzik, 5400 Renaissance Tower, 1201 Elm Street, Dallas, TX, 75270, US

(73) Assignee: International Business Machines Corporation, Armonk, NY

(21) Appl. No.: 09/892,964

(22) Filed: Jun. 27, 2001

(51) Int. Cl. H04M 3/42

(52) U.S. Cl. 455/414; 455/426; 455/566

(57) ABSTRACT

In a wireless telecommunications network, when a wireless telephone user is placed on an on-hold status by the other party, additional information/data is downloaded (pushed) to the telephone user's display screen on their telephone using a wireless application protocol to the user's web-enabled telephone. There are thus parallel connections established—the voice connection and the data connection downloading the web page.

### TECHNICAL FIELD

The present invention relates in general to wireless telecommunications, and in particular, to the transmission of voice and data over wireless telephone networks.

### BACKGROUND INFORMATION

Wireless telecommunications is still in its infancy. The proliferation of mobile telephones began in the 1980's, and has skyrocketed to the point where even adolescents possess cell phones. The cell phone era began with analog networks, but has quickly transformed into a digital format sweeping across the nation.

In parallel, the 1990's have seen the meteoric rise of e-commerce and the Internet. Until recently, cell phones have been utilized solely for voice communications, but a marriage of the Internet and digital cell networks is quickly creating an integrated technology permitting cell phone users to communicate both voice and data. One can now sign up for wireless telephone services and acquire a cell phone with an internal web browser for accessing websites specifically configured for the small display screens of such cell phones. As a result, a wireless telephone user cannot only have a voice conversation with another party, but can alternatively review email, stock quotes, weather, etc., using the internal web browser on the cell phone.

Nevertheless, all of this emerging technology has not eliminated vices of telecommunications, such as being placed on hold by a business. Being placed on hold indefinitely naturally leads to irritation and frustration for a business' customers, which is not good for business. With a cell phone, the situation is worsened by the fact that cell phone users often have to pay for telephone use by the minute. In today's fast paced world, being placed on hold can take up valuable time that could be spent doing something else. Therefore, there is a need in the art for making better use of the time that a customer is placed on hold in order to lower irritation and frustration by customers.

### SUMMARY OF THE INVENTION

The present invention addresses the foregoing need by providing alternative content to a cell phone user when placed on hold. When a cell phone user is placed on hold, additional content is pushed for display to the user on the users cell phone display screen.

In an alternative embodiment, a customer's profile can be downloaded to push content during the hold period that is of particular interest to the customer.

In a digital wireless telecommunications network, the present invention includes in one embodiment a method comprising the steps of receiving a voice call from a user of a cell phone, conducting a voice conversation with the user of the cell phone, and while maintaining the voice call with the user of the cell phone, downloading content to the cell phone for display on a display screen of the cell phone.

In another embodiment of the present invention, there is provided a computer program product adaptable for storage on a computer readable medium, the computer program product comprising the program steps of receiving a voice call from a user of a cell phone, conducting a voice conversation with the user of the cell phone, and in parallel with maintaining the voice call with the user of the cell phone, downloading content to the cell phone for display on a display screen of the cell phone.

Another embodiment of the present invention embodies an information handling system comprising a database storing html code for displaying a web page on a web enabled phone, a switch for coupling to a telecommunications network and for connecting an extension to a cell phone over the telecommunications network, and an application server for downloading the web page to the web enabled phone in parallel with a voice conversation occurring between the extension and the cell phone.

Another embodiment of the present invention includes a telecommunications network comprising a digital wireless network, a web enabled telephone, a switch, a public switched telephone network coupled to the switch and to the digital wireless network, a telephone device coupled to the switch, circuitry for creating a voice connection between the web enabled telephone and the telephone device via the digital wireless network, public switched telephone network, and the switch, and an application server for downloading content to the web enabled telephone in parallel with occurrence of the voice connection.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a flow diagram in accordance with the present invention;

FIG. 2 illustrates a block diagram of a network configured in accordance with the present invention;

FIG. 3 illustrates a block diagram of components within a network utilized to provide services in accordance with the present invention; and

FIG. 4 illustrates a wireless application environment configured in accordance with the present invention.

### DETAILED DESCRIPTION

In the following description, numerous specific details are set forth such as specific protocols or wireless network architectures, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention is implemented within a wireless digital network, such as those presently in place for the connection of digital cell phones, pagers, personal digital assistants, etc. to the public switched telephone network (PSTN) and the Internet. Such a network may communicate using WAP (Wireless Application Protocol), which permits wireless users to access electronic and voice mail, send and receive faxes, make stock trades, conduct banking transactions, view miniature web pages, etc. on a wireless terminal's display screen. More information, including specifications, can be found on WAP at http://www.wapforum.org, which is hereby incorporated by reference herein. WAP makes it easier for mobile users to view shrunken web pages using Wireless Markup Language (WML) which permits websites to tailor the information format to fit the screen of a cell phone.

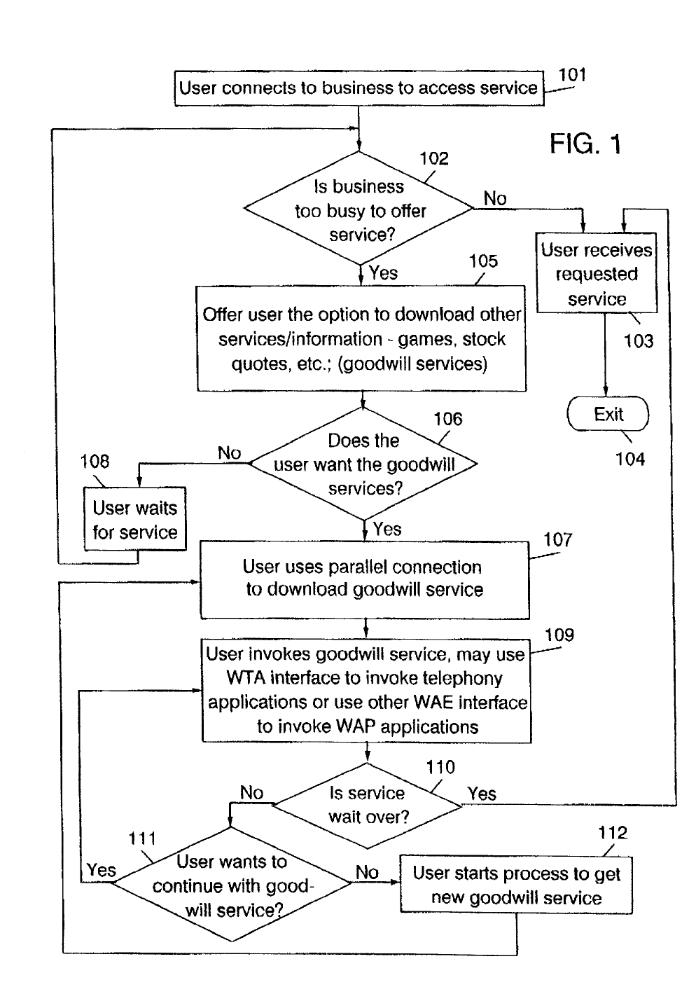

Referring to FIG. 1, there is illustrated a flow diagram of an exemplary process for implementing concepts of the present invention. In step 101, a cell phone (wireless telephone) user connects to a business to converse with the business to access and acquire possible services. In other words, a user dials up a business on their cell phone. In step 102, if the business representative is too busy to converse with the user at that time, then the process will proceed to step 105 and the caller is placed on hold. If the business representative can converse with the user, the process will proceed from step 102 to step 103 where the user will receive requested service from the business and the system exits in step 104.

However, if step 105 occurs, the user will be placed on hold, and in accordance with an embodiment of the present invention, the business will offer the user an option to download other services/information (also referred to herein as “goodwill” services) to their cell phone, such as games, stock quotes, etc. Such an offer may be a voice message to the user while on hold. If caller ID service is implemented over this network, and this particular user has previously registered with the business, then the business may be able to utilize the caller ID information to identify the user and tailor the services/information to be downloaded to the particular user. For example, the user may have preregistered with this business and expressed a preference to receive stock quotes when placed on hold. Then, when the user calls into the business and is placed on hold, stock quote information will be downloaded to the user's cell phone. In step 106, the process determines whether the user wishes to receive such alternative “goodwill” services. This step may be performed by offering the alternative goodwill services to the user and requesting the user to dial or voice a digit (e.g., “1”) to authorize the download of alternative services/information. If the user does not wish to receive such additional goodwill services, the process will proceed to step 108, where the user will wait for the service the user originally called for (to be taken off hold), and the process returns to step 102 where the caller remains on hold. However, if the user does elect to receive such goodwill services, the process will proceed to step 107 where a parallel connection will be established between the user and the business in a manner described below to download such goodwill services.

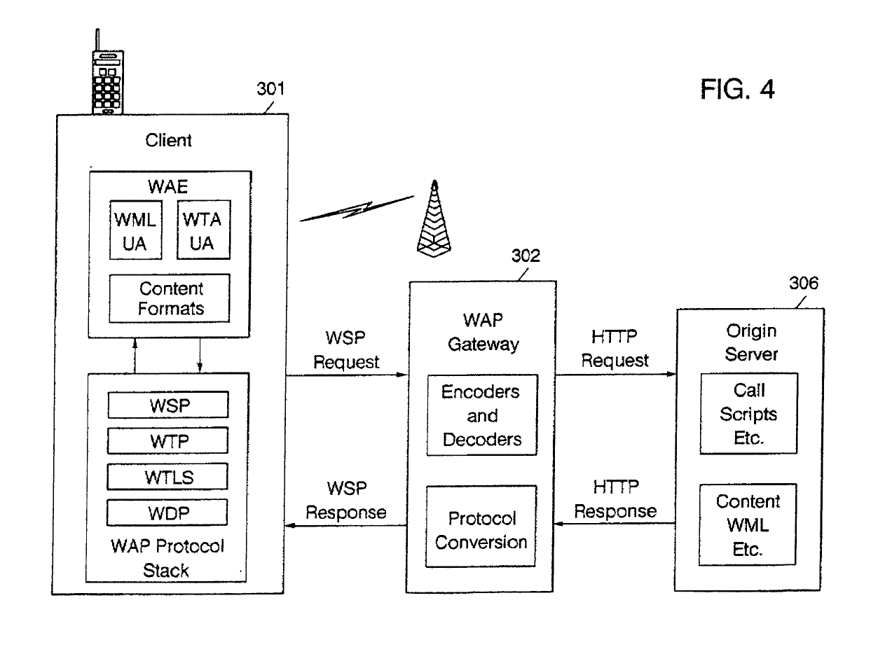

In step 109, the user will invoke the goodwill service, may use a WTA (Wireless Telephony Application) interface to invoke telephony applications, or use other WAE (Wireless Application Environment) interfaces to invoke WAP applications (see FIG. 4). In step 110, a determination is made whether the on-hold status is to continue. If not, the process will proceed to step 103 where the user will then be serviced as requested by the user. However, if the user is to remain on hold in step 110, the process will proceed to step 111 where an optional step may be performed to request whether the user wishes to continue with the previous goodwill services. If yes, the process merely returns to step 109 to continue providing such additional goodwill services. However, if the user does not wish to continue with such goodwill services, the process will proceed to step 112 where a process will begin to provide different goodwill services to the user. The method returns to step 107. As an example, the initial goodwill services provided to the user may be a particular game downloaded for the user to play on their cell phone. If the user tires of this game in step 111, the process begun in step 112 can initiate a process where a different game can be downloaded to the user.

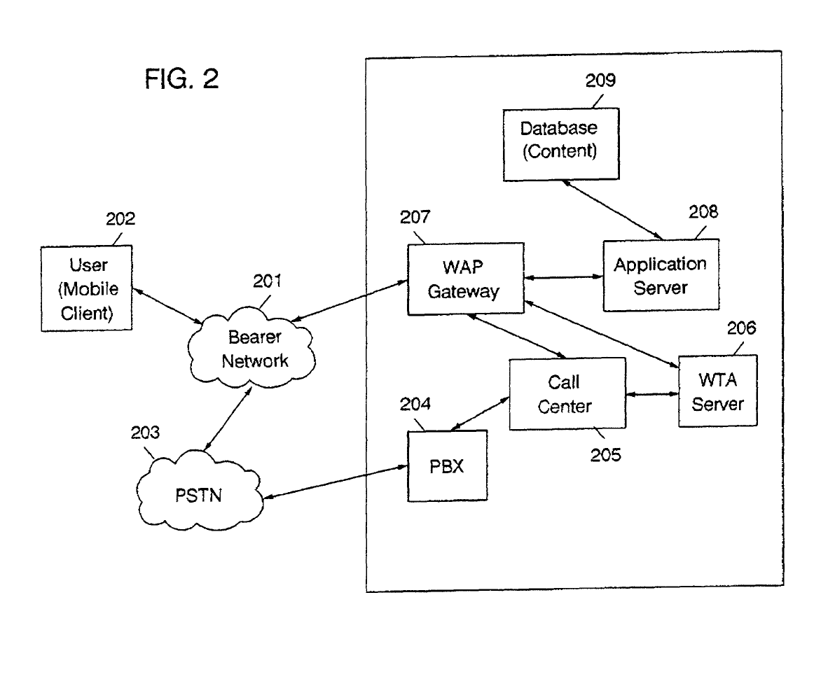

Referring to FIG. 2, there is illustrated a wireless network configured in accordance with the present invention. A user with a cell phone 202 has access to the wireless network through a bearer network 201, which may be provided by such entities as MCI, Sprint, AT&T, etc. Such networks 201 will connect the cell phone user 202 to the PSTN (public switched telephone network) 203. If a user calls a particular business, then the PSTN 203 will connect the user's telephone call to the business' PBX 204, which switches it to the called extension, which in this example may be the business' call center 205. It is the call center 205 that may place the user 202 in an on-hold status as discussed above with respect to FIG. 1.

When a call center 205 receives a call from a cell phone/mobile user 202 through networks 201 and 203, and then has to put the user 202 on hold, it obtains the user profile to determine what content to push. This can be accomplished by comparing the caller ID information of the caller to a database of user preferences. This content will then be pushed to the user 202 on a parallel channel. This is accomplished by generating content via the application server 208 and invoking the WAP push services to push the content. Web push services utilize a push proxy gateway through which data and services are pushed to a specified web client. The WAP has standard interfaces through which such push services can be invoked and accomplished. Otherwise, if the business does not have access to a user profile for user 202, the user 202 can select services by using the WTA server 206 in conjunction with the WAP push services to allow the business to push to the client selected services. The user's call sets up the initial voice connection (client 202—bearer network 201—PSTN 203—PBX 204—call center 205), and based on the client's choices (in the first connection) a second connection (client 202—bearer network 201—WAP gateway 207—application server 208) is created from the business to the client through which data and services are pushed to the client. The WTAI interfaces (see FIG. 4) on the client and push proxy services on the server can be utilized to implement this second connection. At this point there are two parallel channels between the client and the business—an exploitation of packet-based networking capabilities.

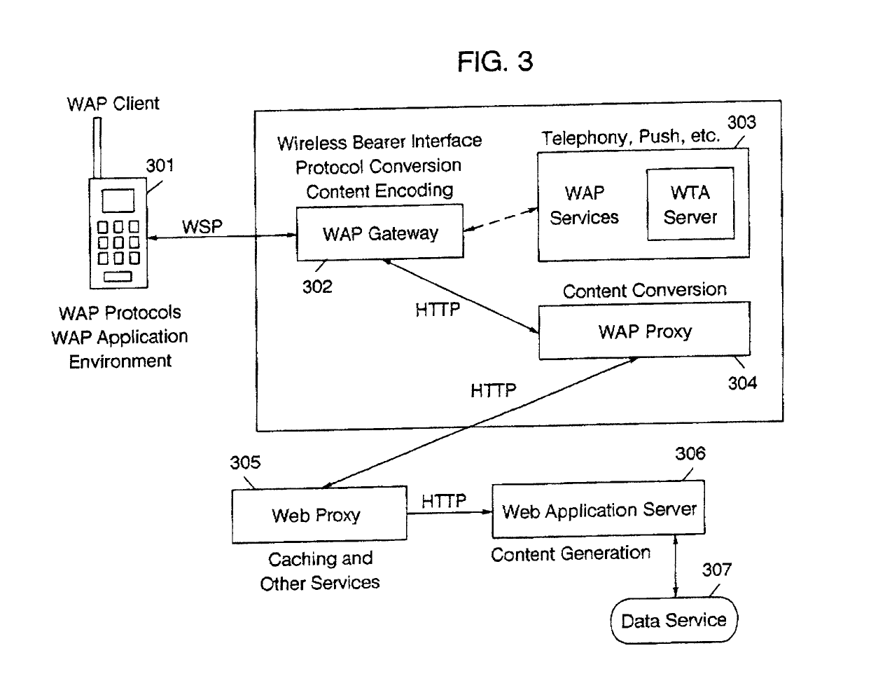

FIG. 3 illustrates an embodiment of a configuration of an end-to-end network infrastructure supporting a WAP client for pushing goodwill services to the client. A WAP client 301, on one end of the WAP stack has the WML browser, push client and telephony application environment and can be a cell phone, PDA, or any other device supporting WAP. The WAP gateway 302 bridges the wireless protocols with the wireline protocols. WSP (Wireless Session Protocol) requests are converted to HTTP requests sent over the Internet. The WAP proxy 304 manipulates the WAP content to make it suitable for WAP clients such as content conversion, tailoring to client capabilities, etc. WAP services 303 provide services beyond the web services such as WAP push services through a push proxy gateway and WAP telephony applications through the telephony server. The web proxy 305 provides various services for web clients while the web server 306 (origin server) generates content to deliver to a client 301. The data source 307 contains data that is accessed and transformed in the provisioning of such useful client services.

Referring next to FIG. 4, there is illustrated further detail of how the goodwill services may be provided over the parallel connection (see FIG. 2) to the client wireless device 301. FIG. 4 illustrates the delivery of a WSP request from the client side to the WAP gateway 302 and its decoding and protocol conversion to an HTTP request that is served by an origin server 306 using CGI scripts, etc. At this point, WML content may be generated directly or content in some other format may be generated which is sent as an HTTP response. The WAP gateway 302 does necessary encoding and protocol conversion and sends it as a WSP response to the original query.

The wireless application environment (WAE) defines formats for downloading content and application and also means for delivery of content from applications servers in a WAP environment. The Wireless telephony application interface (WTAI) within the WAE of the client device 301 represents a collection of services used by a WML application to interact with the telephony features of the client device 301. These include the capabilities to initiate a phone call, send DTMF tones, accepting and setting up incoming calls, sending and receiving network text messages, placing a call on hold, transferring the call, etc. The wireless telephony application (WTA) user agent (UA) supports downloading of catalogues or bundles of new telephony libraries and event-handling capabilities that allow access to value-added telephony services. In this instance, it allows the parallel invocation of a service download when a user is put on hold.

The wireless session protocol (WSP) supports the notion of a session between two application peers. The wireless transaction protocol (WTP) is loosely based on TCP (Transmission Control Protocol) and supports the notion of transactions—client requests and server responses, and is built on top of a datagram service provided by the wireless datagram protocol (WDP). The wireless transport layer security (WTLS) provides authentication and data encryption services.

Although the present invention and its advantages have been described in detail, it should be understood that various changes, substitutions and alterations can be made herein without departing from the spirit aby the appended claims.

What is claimed is:

1. In a digital wireless telecommunications network, a method comprising the steps of:
receiving a voice call from a user of a cell phone;
conducting a voice conversation with the user of the cell phone; and
while maintaining the voice call with the user of the cell phone, downloading content to the cell phone for display on a display screen of the cell phone.

2. The method as recited in claim 1, wherein the content is a web page from a web server on the Internet.

3. The method as recited in claim 1, further comprising the step of:
placing the voice call in an on hold status, wherein the downloading step is performed while the voice call is in the on hold status.

4. The method as recited in claim 2, wherein the web page is downloaded to the cell phone from the web server after being converted into a wireless application protocol format by a gateway coupling the Internet to the digital wireless telecommunications network.

5. The method as recited in claim 4, wherein the html of the web page is converted into wireless markup language by the gateway.

6. The method as recited in claim 3, wherein after the voice call is placed in an on hold status, a voice message is played to the user via the cell phone requesting the user to select the download of the content.

7. The method as recited in claim 1, wherein the downloading step further comprises the step of using caller ID pertaining to the cell phone to select a particular content to download to the cell phone.

8. The method as recited in claim 1, wherein the voice call and the download of the content are performed in parallel over a connection between the cell phone and the network using a packet switched protocol.

9. The method as recited in claim 3, further comprising the step of:
discontinuing the downloading of the content when the on hold status is discontinued.

10. A computer program product adaptable for storage on a computer readable medium, the computer program product comprising the program steps of:
receiving a voice call from a user of a cell phone;
conducting a voice conversation with the user of the cell phone; and
in parallel with maintaining the voice call with the user of the cell phone, downloading content to the cell phone for display on a display screen of the cell phone.

11. The computer program product as recited in claim 10, wherein the content is a web page from a web server on the Internet.

12. The computer program product as recited in claim 11, further comprising the program step of:
placing the voice call in an on hold status, wherein the downloading program step is performed while the voice call is in the on hold status.

13. The computer program product as recited in claim 12, wherein after the voice call is placed in an on hold status, a voice message is played to the cell phone requesting the user to authorize the download of the content.

14. The computer program product as recited in claim 12, wherein the downloading program step further comprises the program step of using caller ID pertaining to the cell phone to select a particular content to download to the cell phone.

15. The computer program product as recited in claim 12, further comprising the program step of:
discontinuing the downloading of the content when the on hold status is discontinued.

16. An information handling system comprising:
a database storing html code for displaying a web page on a web enabled phone;
a switch for coupling to a telecommunications network and for connecting an extension to a cell phone over the telecommunications network; and
an application server for downloading the web page to the web enabled phone in parallel with a voice conversation occurring between the extension and the cell phone.

17. The system as recited in claim 16, further comprising:
a gateway coupled between the application server and the telecommunications network for converting the html code of the web page to wireless markup language so that the web page can be displayed on a display screen of the web enabled phone.

18. The system as recited in claim 17, wherein the telecommunications network between the cell phone and the switch comprises a bearer wireless network and a public switched telephone network.

19. The system as recited in claim 18, wherein the gateway is coupled to the cell phone via the bearer wireless network.

20. The system as recited in claim 19, wherein the telecommunications network is packet switched permitting parallel downloads.

21. A telecommunications network comprising:
a digital wireless network;
a web enabled telephone;
a switch;
a public switched telephone network coupled to the switch and to the digital wireless network;
a telephone device coupled to the switch;
circuitry for creating a voice connection between the web enabled telephone and the telephone device via the digital wireless network, public switched telephone network, and the switch; and
an application server for downloading content to the web enabled telephone in parallel with occurrence of the voice connection.

22. The network as recited in claim 21, wherein the content is a web page formatted for display on a display screen of the web enabled telephone.

23. The network as recited in claim 22, further comprising:
a wireless application protocol gateway for converting html code of the web page received from the application server into wireless markup language for transmission to the web enabled telephone over the digital wireless network.

24. The network as recited in claim 23, further comprising circuitry for downloading the content to the web enabled telephone when the web enabled telephone is placed in an on hold state by the telephone device.

25. The network as recited in claim 21, wherein the web enabled telephone is displaying the content simultaneously with the voice connection.
